(19) United States
(12) Patent Application Publication
(10) Pub. No.: US 2023/0122586 A1
(43) Pub. Date: Apr. 20, 2023

(54) ANTENNA DEVICE AND DISPLAY DEVICE INCLUDING THE SAME

(71) Applicant: DONGWOO FINE-CHEM CO., LTD., Jeollabuk-do (KR)

(72) Inventors: Hee Jun PARK, Gyeonggi-do (KR); Ho Dong YOON, Gyeonggi-do (KR); Won Hee LEE, Incheon (KR)

(21) Appl. No.: 18/082,639

(22) Filed: Dec. 16, 2022

Related U.S. Application Data
(63) Continuation of application No. PCT/KR2021/007594, filed on Jun. 17, 2021.

(30) Foreign Application Priority Data
Jun. 24, 2020 (KR) 10-2020-0076855

(51) Int. Cl. H01Q 9/04; H01Q 1/24; H01Q 1/48; H01Q 5/307

(52) U.S. Cl. CPC H01Q 9/045; H01Q 1/243; H01Q 1/48; H01Q 5/307

(57) ABSTRACT

An antenna device according to an embodiment may include a dielectric layer, a first radiator disposed on an upper surface of the dielectric layer, a transmission line whose one end is connected with the first radiator on the upper surface of the dielectric layer, a signal pad connected to the other end of the transmission line, ground pads disposed around the signal pad, and a second radiator extending from the ground pad parallel to the transmission line and including one or more uneven parts.

### CROSS REFERENCE TO RELATED APPLICATIONS AND CLAIM OF PRIORITY

The present application is a continuation application to International Application No. PCT/KR2021/007594 filed on Jun. 17, 2021, which claims the benefit of Korean Patent Applications No. 10-2020-0076855 filed on Jun. 24, 2020 at the Korean Intellectual Property Office, the disclosures of which are incorporated by reference herein in their entirety.

### BACKGROUND

### 1. Field

The present invention relates to an antenna device and a display device including the same.

### 2. Description of the Related Art

Recently, according to development of the information-oriented society, wireless communication techniques such as Wi-Fi, Bluetooth, and the like are implemented, for example, in a form of smartphones by combining with display devices. In this case, an antenna may be coupled to the display device to perform a communication function.

Recently, with mobile communication techniques becoming more advanced, it is necessary for an antenna for performing communication in ultra-high frequency bands to be coupled to the display device.

In addition, as the display device on which the antenna is mounted becomes thinner and lighter, a space occupied by the antenna may also be reduced. Accordingly, it is not easy to simultaneously implement the transmission and reception of high frequency and wideband signals within a limited space.

For example, in the case of recent 5G mobile communication in high frequency bands, as the wavelength is shorter, a case in which signal transmission and reception may be blocked occurs, and it may be necessary to implement the transmission and reception of multi-band signals.

Therefore, it is necessary to apply an antenna to a display device in a form of a film or a patch, and in order to implement the above-described high frequency communication, a structural design of the antenna to secure the reliability of radiation characteristics is required despite a thin structure.

For example, Korean Patent Laid-Open Publication No. 2010-0114091 discloses a dual patch antenna module, but it may not be sufficient to be applied to a small device because the antenna module is manufactured in a thin shape within a limited space.

### SUMMARY

It is an object of the present invention to provide an antenna device and a display device including the same.

To achieve the above objects, the following technical solutions are adopted in the present invention.

1. An antenna device including: a dielectric layer; a first radiator disposed on an upper surface of the dielectric layer; a transmission line whose one end is connected with the first radiator on the upper surface of the dielectric layer; a signal pad connected to the other end of the transmission line; ground pads disposed around the signal pad; and a second radiator extending from the ground pad parallel to the transmission line and including one or more uneven parts.

2. The antenna device according to the above 1, wherein the one or more uneven parts are formed on one side of the second radiator facing the first radiator.

3. The antenna device according to the above 1, wherein a height and a width of each of the one or more uneven parts are determined depending on a desired resonance frequency of the second radiator.

4. The antenna device according to the above 1, wherein the second radiator is electrically and physically spaced apart from the first radiator and the transmission line.

5. The antenna device according to the above 1, wherein the second radiator and the ground pad are formed as a single member.

6. The antenna device according to the above 1, wherein the second radiator is formed in a mesh structure, and the ground pad is formed in a solid structure.

7. The antenna device according to the above 1, wherein the resonance frequency of the second radiator is higher than the resonance frequency of the first radiator.

8. The antenna device according to the above 1, wherein the second radiator includes a pair of second radiators disposed so as to face each other with the transmission line interposed therebetween on the upper surface of the dielectric layer.

9. The antenna device according to the above 1, wherein at least one of the first radiator, the transmission line and the second radiator is formed in a mesh structure.

10. The antenna device according to the above 1, further including a ground layer disposed on a lower surface of the dielectric layer.

11. A display device including the antenna device according to the above 1.

According to the present invention, by disposing the first radiator and the second radiator on the upper surface of the dielectric layer, it is possible to implement a dual band antenna.

In addition, by forming one or more uneven parts in the second radiator, the second radiator may be finely tuned to a desired resonance frequency, and thereby improving the radiation effect of the second radiator.

Further, by forming at least a portion of the antenna conductive layer of the antenna device in a mesh structure, it is possible to improve a transmittance of the antenna device, and suppress the antenna device from being viewed by a user when mounting it on the display device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic cross-sectional view illustrating an antenna device according to an embodiment;

FIG. 2 is a schematic plan view illustrating the antenna device according to an embodiment;

FIG. 3 is a schematic plan view illustrating an antenna device according to another embodiment;

FIG. 4 is a schematic plan view illustrating an antenna device according to another embodiment;

FIG. 5 is a schematic plan view illustrating an antenna device according to another embodiment;

FIG. 6 is a schematic plan view illustrating an antenna device according to another embodiment;

FIG. 7 is a schematic plan view illustrating an antenna device according to another embodiment;

FIG. 8 is a diagram for describing a change in a resonance frequency of the second radiator depending on heights of the uneven part;

FIG. 9 is a diagram for describing a change in the resonance frequency of the second radiator depending on widths of the uneven part; and

FIG. 10 is a schematic plan view for describing a display device according to an embodiment.

### DETAILED DESCRIPTION

Hereinafter, preferred embodiments of the present invention will be described in detail with reference to the accompanying drawings. However, since the drawings attached to the present disclosure are only given for illustrating one of preferable various embodiments of present invention to easily understand the technical spirit of the present invention with the above-described invention, it should not be construed as limited to such a description illustrated in the drawings.

An antenna device described in the present disclosure may be a patch antenna or a microstrip antenna manufactured in a form of a transparent film. For example, the antenna device may be applied to electronic devices for high frequency or ultra-high frequency (e.g., 3G, 4G, 5G or more) mobile communication, Wi-Fi, Bluetooth, near field communication (NFC), global positioning system (GPS), and the like, but it is not limited thereto. In addition, the antenna device may be applied to various target structures such as an automobile, a building and the like.

In the following drawings, two directions which are parallel to an upper surface of a dielectric layer and cross each other are defined as a first direction and a second direction. In this case, the first direction and the second direction may cross each other perpendicularly. In addition, a direction perpendicular to the upper surface of the dielectric layer is defined as a third direction. For example, the first direction may correspond to a length direction of the antenna device, the second direction may correspond to a width direction of the antenna device, and the third direction may correspond to a thickness direction of the antenna device.

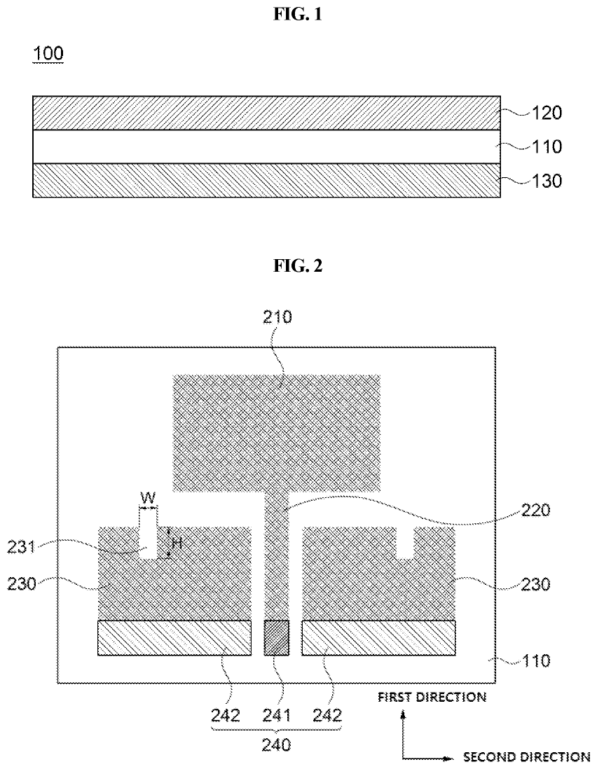

FIG. 1 is a schematic cross-sectional view illustrating an antenna device according to an embodiment.

Referring to FIG. 1, an antenna device 100 may include a dielectric layer 110 and an antenna conductive layer 120.

The dielectric layer 110 may include an insulation material having a predetermined dielectric constant. According to an embodiment, the dielectric layer 110 may include an inorganic insulation material such as glass, silicon oxide, silicon nitride, or metal oxide, or an organic insulation material such as an epoxy resin, an acrylic resin, or an imide resin. The dielectric layer 110 may function as a film substrate of the antenna device on which the antenna conductive layer 120 is formed.

According to an embodiment, a transparent film may be provided as the dielectric layer 110. In this case, the transparent film may include a polyester resin such as polyethylene terephthalate, polyethylene isophthalate, polyethylene naphthalate, polybutylene terephthalate, etc.; a cellulose resin such as diacetyl cellulose, triacetyl cellulose, etc.; a polycarbonate resin; an acrylic resin such as polymethyl (meth)acrylate, polyethyl (meth)acrylate, etc.; a styrene resin such as polystyrene, acrylonitrile-styrene copolymer, etc.; a polyolefm resin such as polyethylene, polypropylene, cyclic polyolefin or polyolefin having a norbomene structure, ethylene-propylene copolymer, etc.; a vinyl chloride resin; an amide resin such as nylon, aromatic polyamide; an imide resin; a polyether sulfonic resin; a sulfonic resin; a polyether ether ketone resin; a polyphenylene sulfide resin; a vinylalcohol resin; a vinylidene chloride resin; a vinylbutyral resin; an allylate resin; a polyoxymethylene resin; a thermoplastic resin such as an epoxy resin and the like. These compounds may be used alone or in combination of two or more thereof. In addition, a transparent film made of a thermosetting resin or an ultraviolet curable resin such as (meth)acrylate, urethane, acrylic urethane, epoxy, silicone, and the like may be used as the dielectric layer 110.

According to an embodiment, an adhesive film such as an optically clear adhesive (OCA), an optically clear resin (OCR), and the like may also be included in the dielectric layer 110.

According to an embodiment, the dielectric layer 110 may be formed in a substantial single layer, or may be formed in a multilayer structure of two or more layers.

Capacitance or inductance may be generated by the dielectric layer 110, thus to adjust a frequency band which can be driven or sensed by the antenna device 100. When the dielectric constant of the dielectric layer 110 exceeds about 12, a driving frequency is excessively reduced, such that driving of the antenna in a desired high frequency band may not be implemented. Therefore, according to an embodiment, the dielectric constant of the dielectric layer 110 may be adjusted in a range of about 1.5 to 12, and preferably about 2 to 12.

According to an embodiment, an insulation layer (e.g., an encapsulation layer, a passivation layer, etc. of a display panel) inside the display device on which the antenna device 100 is mounted may be provided as the dielectric layer 110.

The antenna conductive layer 120 may be disposed on the upper surface of the dielectric layer 110. The antenna conductive layer 120 may include one or more antenna units including a first radiator and a second radiator.

The antenna conductive layer 120 may include a low resistance metal such as silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca), or an alloy including at least one thereof. These may be used alone or in combination of two or more thereof. For example, the antenna conductive layer 120 may include silver (Ag) or a silver alloy (e.g., a silver-palladium-copper (APC) alloy) to implement a low resistance. As another example, the antenna conductive layer 120 may include copper (Cu) or a copper alloy (e.g., a copper-calcium (CuCa) alloy) in consideration of low resistance and fine line width patterning.

According to an embodiment, the antenna conductive layer 120 may include a transparent conductive oxide such as indium tin oxide (ITO), indium zinc oxide (IZO), indium zinc tin oxide (IZTO), or zinc oxide (ZnOx).

According to an embodiment, the antenna conductive layer 120 may include a lamination structure of a transparent conductive oxide layer and a metal layer, for example, may have a two-layer structure of transparent conductive oxide layer-metal layer or a three-layer structure of transparent conductive oxide layer-metal layer-transparent conductive oxide layer. In this case, resistance may be reduced to improve signal transmission speed while improving flexible properties by the metal layer, and corrosion resistance and transparency may be improved by the transparent conductive oxide layer.

According to an exemplary embodiment, the antenna conductive layer 120 may include a blackening processing part. Accordingly, reflectance on a surface of the antenna conductive layer 120 may be decreased, thereby reducing the pattern from being viewed due to light reflection.

According to an embodiment, the surface of the metal layer included in the antenna conductive layer 120 is converted into metal oxide or metal sulfide to form a blackened layer. According to an embodiment, the blackened layer such as a black material coating layer or a plating layer may be formed on the antenna conductive layer 120 or the metal layer. Herein, the black material coating layer or plating layer may include silicon, carbon, copper, molybdenum, tin, chromium, molybdenum, nickel, cobalt, or oxide, sulfide, or an alloy containing at least one of them.

The composition and thickness of the blackened layer may be adjusted in consideration of an effect of reducing reflectance.

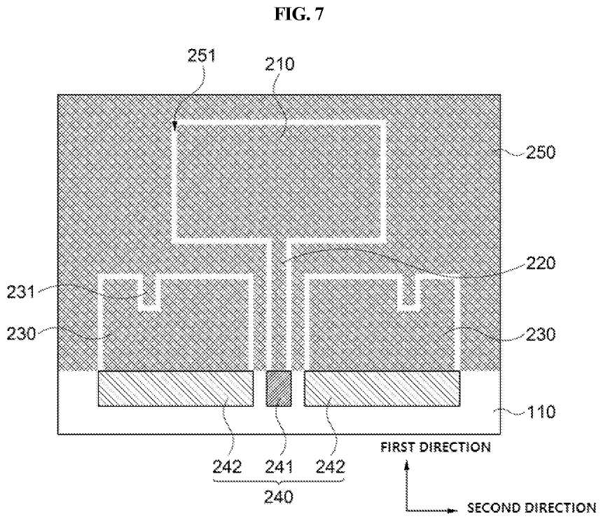

Specific details of the antenna conductive layer 120 will be described below with reference to FIGS. 2 and 7.

According to an embodiment, the antenna device 100 may further include a ground layer 130. Since the antenna device 100 includes the ground layer 130, vertical radiation characteristics may be implemented.

The ground layer 130 may be formed on a lower surface of the dielectric layer 110. The ground layer 130 may be disposed so as to be at least partially overlapped with the antenna conductive layer 120 with the dielectric layer 110 interposed therebetween. For example, the ground layer 130 may be overlapped with the radiator (see 210 and 230 in FIG. 2) of the antenna conductive layer 120.

According to an embodiment, a conductive member of the display device or display panel on which the antenna device 100 is mounted may be provided as the ground layer 130. For example, the conductive member may include electrodes or wirings such as a gate electrode, source/drain electrodes, pixel electrode, common electrode, data line, scan line, etc. of a thin film transistor (TFT) included in the display panel; and a stainless steel (SUS) plate, heat radiation sheet, digitizer, electromagnetic shielding layer, pressure sensor, fingerprint sensor, etc. of the display device.

FIG. 2 is a schematic plan view illustrating the antenna device according to an embodiment.

Referring to FIGS. 1 and 2, the antenna device 100 according to an embodiment may include the antenna conductive layer 120 formed on the upper surface of the dielectric layer 110. Herein, the antenna conductive layer 120 may include an antenna unit including a first radiator 210 and second radiators 230, a transmission line 220 and a pad electrode 240.

The first radiator 210 may be formed in a mesh structure. Thereby, transmittance of the first radiator 210 may be increased, and flexibility of the antenna device 100 may be improved. Therefore, the antenna device 100 may be effectively applied to a flexible display device.

A length of the first radiator 210 in the first direction may be determined depending on a desired first resonance frequency, and a width of the first radiator 210 in the second direction may be determined depending on a desired radiation resistance and gain. According to an embodiment, the first resonance frequency may belong to a band of 28 GHz, but it is not limited thereto.

The first radiator 210 may be electrically connected to the transmission line 220 to be supplied with a power through the transmission line 220.

According to one embodiment, as shown in FIG. 2, the first radiator 210 may be implemented in a rectangular shape. However, this is only an example and there is no particular limitation on the shape of the first radiator 210. That is, the first radiator 210 may be implemented in various shapes such as a rhombus, circle and the like.

The transmission line 220 is disposed between the first radiator 210 and a signal pad 241 of the pad electrode 240, and may be branched from a central portion of the first radiator 210 to electrically connect the first radiator 210 and the signal pad 241.

According to an embodiment, the transmission line 220 may include substantially the same conductive material as the first radiator 210. Further, the transmission line 220 may be formed as a substantial single member by integrally connecting with the first radiator 210, or may be formed as a separate member from the first radiator 210.

According to an embodiment, the transmission line 220 may be formed in a mesh structure having substantially the same shape (e.g., having the same line width, the same interval, etc.) as the first radiator 210.

The second radiator 230 may be electrically and physically spaced apart from the first radiator 210 and the transmission line 220, and may be coupled to the first radiator 210 and the transmission line 220 to be supplied with a power. The second radiator 230 may extend from ground pads 242 of the pad electrode 240 to the first radiator 210 in parallel to the transmission line 220. For example, a pair of second radiators 230 may be formed in a coplanar waveguide with ground (CPW ground) structure disposed to face each other with the transmission line 220 interposed therebetween on the upper surface of the dielectric layer 110 having the ground layer 130 disposed on a lower surface thereof.

According to an embodiment, the second radiator 230 may be formed as a substantial single member by integrally connecting with the ground pad 242, or may be formed as a separate member from the ground pad 242. In addition, the second radiator 230 may have a width which is formed smaller than, equal to, or larger than the width of the ground pad 242.

The second radiator 230 may include an uneven part 231 recessed into an inside the second radiator 230.

The uneven part 231 may be formed on one side of the second radiator 230 facing the first radiator 210. At this time, one side of the second radiator 230 facing the first radiator 210 is a side of the second radiator 230 positioned in the first direction, and may include both a region which is overlapped with the first radiator 210 and a region which is not overlapped therewith in the first direction. A location, height H, and width W of the uneven part 231 may be determined depending on the desired resonance frequency, radiation resistance, and gain of the second radiator 230 in consideration of the length in the first direction and the width in the second direction of the second radiator 230. According to an embodiment, the second resonance frequency may be higher than the first resonance frequency. For example, the second resonance frequency may belong to a band of 38 GHz, but it is not limited thereto.

According to an embodiment, the second radiator 230 may be formed in a mesh structure having substantially the same shape (e.g., having the same line width, the same interval, etc.) as the first radiator 210. Thereby, it is possible to improve a transmittance of the antenna unit, and suppress the antenna device from being viewed by a user when the antenna device 100 is mounted on the display device. The second radiator 230 may include substantially the same conductive material as the first radiator 210.

As shown in FIG. 2, the second radiator 230 may be formed in a coplanar waveguide with ground (CPW ground) structure, and it may be difficult to finely tune the resonance frequency of the second radiator 230 having the CPW ground structure. In the antenna device according to an embodiment, the uneven part 231 is formed in the second radiator 230, and the height H and/or the width W of the uneven part 231 are/is adjusted, thereby it may be implemented so that the resonance frequency of the second radiator 230 having the CPW ground structure is more accurately matched with the desired second resonance frequency. That is, according to an embodiment, the length and width of the second radiator 230 may be determined to coarsely tune the resonance frequency of the second radiator 230 to the desired second resonance frequency, and the height and/or width of the uneven part 231 may be determined to finely tune the resonance frequency of the second radiator 230 to the desired second resonance frequency. Thereby, it is possible to improve a radiation effect of the second radiator 230.

The pad electrode 240 may include a signal pad 241 and ground pads 242.

The signal pad 241 may be connected to an end of the transmission line 220, thus to be electrically connected with the first radiator 210 through the transmission line 220. Thereby, the signal pad 241 may electrically connect a driving circuit unit (e.g., an IC chip, etc.) and the first radiator 210. For example, a circuit board such as a flexible printed circuit board (FPCB) may be bonded to the signal pad 241, and a driving circuit unit may be mounted on the flexible printed circuit board. Accordingly, the first radiator 210 and the driving circuit unit may be electrically connected with each other.

The ground pads 242 may be disposed around the signal pad 241 so as to be electrically and physically separated from the signal pad 241. For example, a pair of ground pads 242 may be disposed to face each other with the signal pad 241 interposed therebetween.

According to an embodiment, the signal pad 241 and the ground pad 242 may be formed in a solid structure including the above-described metal or alloy to reduce signal resistance.

Meanwhile, for convenience of description, FIG. 2 illustrates only one antenna unit, but a plurality of antenna units may be arranged on the upper surface of the dielectric layer 110 in an array form. In this case, a separation distance between the antenna units may be greater than half of a wavelength corresponding to the resonance frequency (e.g., the first resonance frequency or the second resonance frequency) of the antenna unit in order to minimize radiation interference from each antenna unit.

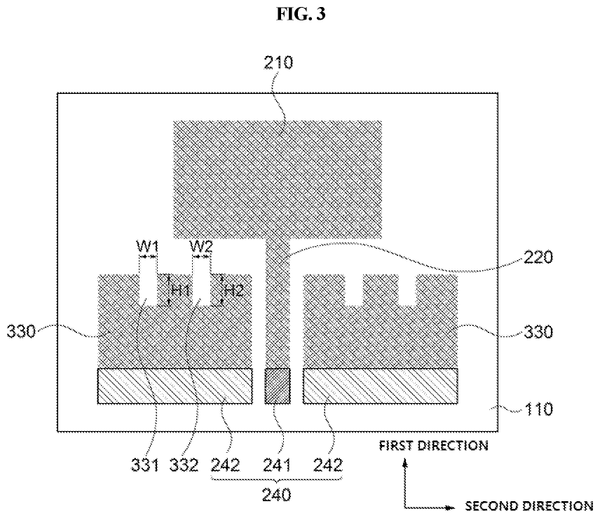

FIG. 3 is a schematic plan view illustrating an antenna device according to another embodiment.

Referring to FIGS. 1 and 3, the antenna conductive layer 120 may include an antenna unit including a first radiator 210 and second radiators 330, a transmission line 220, and a pad electrode 240. Herein, the first radiator 210, the transmission line 220 and the pad electrode 240 are the same as those of the configuration described with reference to FIG. 2, therefore the same configuration will not be described in detail. In addition, the second radiator 330 is similar to the second radiator 230 shown in FIG. 2, therefore it will not be described in detail within the overlapping range.

The second radiator 330 may include two or more uneven parts 331 and 332 recessed into an inside the second radiator 330 at an interval.

The two or more uneven parts 331 and 332 may be formed on one side of the second radiator 330 facing the first radiator 210. In other words, the uneven parts 331 and 332 may be formed on an opposite side of the side connected with the ground pad 242 in the second radiator 230. Positions, heights H1 and H2, and widths W1 and W2 of the uneven parts 331 and 332 may be determined depending on the desired resonance frequency, radiation resistance, and gain of the second radiator 330 in consideration of the length in the first direction and the width in the second direction of the second radiator 330. According to an embodiment, the heights H1 and H2 and widths W1 and W2 of the respective uneven parts 331 and 332 may be the same as or different from each other.

As shown in FIG. 3, the second radiator 330 may be formed in a coplanar waveguide with ground (CPW ground) structure, and it may be difficult to finely tune the resonance frequency of the second radiator 330 having the CPW ground structure. In the antenna device according to an embodiment, the two or more uneven parts 331 and 332 are formed in the second radiator 330, and the heights H1 and H2 and/or widths W1 and W2 of the uneven parts 331 and 332 are adjusted respectively, thereby it may be implemented so that the resonance frequency of the second radiator 330 having the CPW ground structure is more accurately matched with the desired second resonance frequency. That is, according to an embodiment, the length and width of the second radiator 330 may be determined to coarsely tune the resonance frequency of the second radiator 330 to the desired second resonance frequency, and the heights and/or widths of the respective uneven parts 331 and 332 may be determined to finely tune the resonance frequency of the second radiator 330 to the desired second resonance frequency. Thereby, it is possible to improve the radiation effect of the second radiator 330.

Meanwhile, for convenience of description, FIG. 3 illustrates only one antenna unit, a plurality of antenna units may be arranged on the upper surface of the dielectric layer 110 in an array form. In this case, the separation distance between the antenna units may be greater than half of a wavelength corresponding to the resonance frequency (e.g., the first resonance frequency or the second resonance frequency) of the antenna unit in order to minimize radiation interference from each antenna unit.

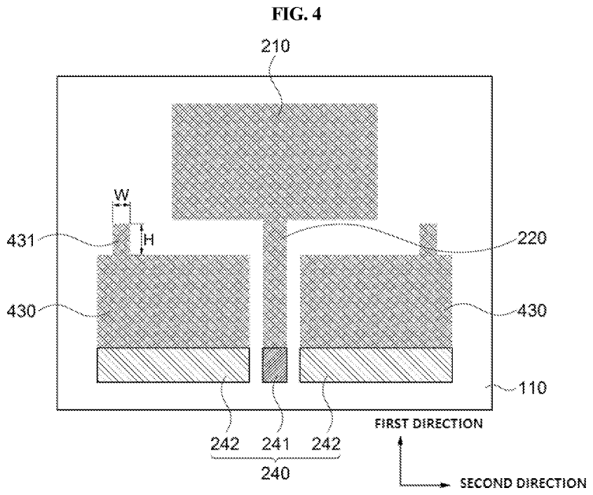

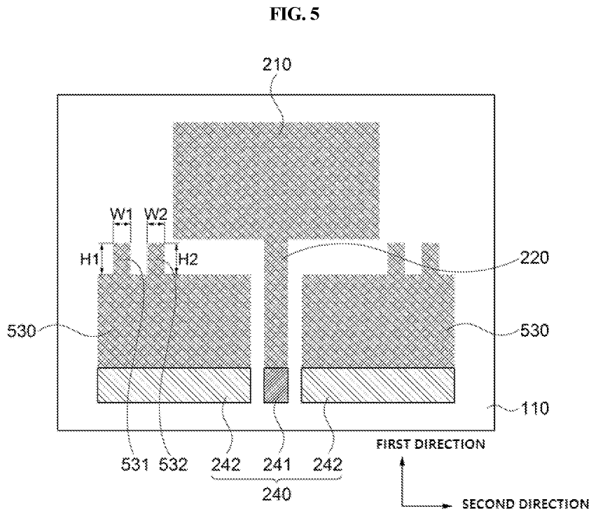

FIG. 4 is a schematic plan view illustrating an antenna device according to another embodiment.

Referring to FIGS. 1 and 4, the antenna conductive layer 120 may include an antenna unit including a first radiator 210 and second radiators 430, a transmission line 220, and a pad electrode 240. Herein, the first radiator 210, the transmission line 220 and the pad electrode 240 are the same as those of the configuration described with reference to FIG. 2, therefore the same configuration will not be described in detail. In addition, the second radiator 430 is similar to the second radiator 230 shown in FIG. 2, therefore it will not be described in detail within the overlapping range.

The second radiator 430 may include an uneven part 431 protruding to an outside of the second radiator 430.

The uneven part 431 may be formed on one side of the second radiator 430 facing the first radiator 210. A position, height H, and width W of the uneven part 431 may be determined depending on the desired resonance frequency, radiation resistance, and gain of the second radiator 430 in consideration of the length in the first direction and the width in the second direction of the second radiator 430.

As shown in FIG. 4, the second radiator 430 may be formed in a coplanar waveguide with ground (CPW ground) structure, and it may be difficult to finely tune the resonance frequency of the second radiator 430 having the CPW ground structure. In the antenna device according to an embodiment, the uneven part 431 is formed in the second radiator 430, and the height H and/or the width W of the uneven part 431 are/is adjusted, thereby it may be implemented so that the resonance frequency of the second radiator 430 having the CPW ground structure is more accurately matched with the desired second resonance frequency. That is, according to an embodiment, the length and width of the second radiator 430 may be determined to coarsely tune the resonance frequency of the second radiator 430 to the desired second resonance frequency, and the height and/or width of the uneven part 431 may be determined to finely tune the resonance frequency of the second radiator 430 to the desired second resonance frequency. Thereby, it is possible to improve a radiation effect of the second radiator 430.

Meanwhile, for convenience of description, FIG. 4 illustrates only one antenna unit, but a plurality of antenna units may be arranged on the upper surface of the dielectric layer 110 in an array form. In this case, a separation distance between the antenna units may be greater than half of a wavelength corresponding to the resonance frequency (e.g., the first resonance frequency or the second resonance frequency) of the antenna unit in order to minimize radiation interference from each antenna unit.

FIG. 5 is a schematic plan view illustrating an antenna device according to another embodiment.

Referring to FIGS. 1 and 5, the antenna conductive layer 120 may include an antenna unit including a first radiator 210 and second radiators 530, a transmission line 220, and a pad electrode 240. Herein, the first radiator 210, the transmission line 220 and the pad electrode 240 are the same as those of the configuration described with reference to FIG. 2, therefore the same configuration will not be described in detail. In addition, the second radiator 530 is similar to the second radiator 230 shown in FIG. 2, therefore it will not be described in detail within the overlapping range.

The second radiator 530 may include two or more uneven parts 531 and 532 protruding to an outside of the second radiator 530.

The two or more uneven parts 531 and 532 may be formed on one side of the second radiator 530 facing the first radiator 210. Positions, heights H1 and H2, and widths W1 and W2 of the uneven parts 531 and 532 may be determined depending on the desired resonance frequency, radiation resistance, and gain of the second radiator 530 in consideration of the length in the first direction and the width in the second direction of the second radiator 530. According to an embodiment, the heights H1 and H2 and widths W1 and W2 of the respective uneven parts 531 and 532 may be the same as or different from each other.

As shown in FIG. 5, the second radiator 530 may be formed in a coplanar waveguide with ground (CPW ground) structure, and it may be difficult to finely tune the resonance frequency of the second radiator 530 having the CPW ground structure. In the antenna device according to an embodiment, the two or more uneven parts 531 and 532 are formed in the second radiator 530, and the heights H1 and H2 and/or widths W1 and W2 of the uneven parts 531 and 532 are adjusted respectively, thereby it may be implemented so that the resonance frequency of the second radiator 530 having the CPW ground structure is more accurately matched with the desired second resonance frequency. That is, according to an embodiment, the length and width of the second radiator 530 may be determined to coarsely tune the resonance frequency of the second radiator 530 to the desired second resonance frequency, and the heights and/or widths of the respective uneven parts 531 and 532 may be determined to finely tune the resonance frequency of the second radiator 530 to the desired second resonance frequency. Thereby, it is possible to improve the radiation effect of the second radiator 530.

Meanwhile, for convenience of description, FIG. 5 illustrates only one antenna unit, a plurality of antenna units may be arranged on the upper surface of the dielectric layer 110 in an array form. In this case, the separation distance between the antenna units may be greater than half of a wavelength corresponding to the resonance frequency (e.g., the first resonance frequency or the second resonance frequency) of the antenna unit in order to minimize radiation interference from each antenna unit.

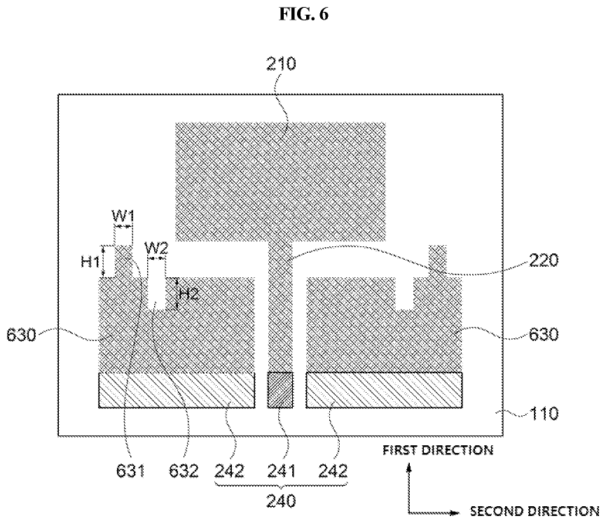

FIG. 6 is a schematic plan view illustrating an antenna device according to another embodiment.

Referring to FIGS. 1 and 6, the antenna conductive layer 120 may include an antenna unit including a first radiator 210 and second radiators 630, a transmission line 220, and a pad electrode 240. Herein, the first radiator 210, the transmission line 220 and the pad electrode 240 are the same as those of the configuration described with reference to FIG. 2, therefore the same configuration will not be described in detail. In addition, the second radiator 630 is similar to the second radiator 230 shown in FIG. 2, therefore it will not be described in detail within the overlapping range.

The second radiator 630 may include two or more uneven parts 631 and 632. The first uneven part 631 may be recessed into an inside of the second radiator 630, and the second uneven part 632 may protrude to an outside of the second radiator 630.

The two or more uneven parts 631 and 632 may be formed on one side of the second radiator 630 facing the first radiator 210. Positions, heights H1 and H2, and widths W1 and W2 of the uneven parts 631 and 632 may be determined depending on the desired resonance frequency, radiation resistance, and gain of the second radiator 630 in consideration of the length in the first direction and the width in the second direction of the second radiator 630. According to an embodiment, the heights H1 and H2 and widths W1 and W2 of the respective uneven parts 631 and 632 may be the same as or different from each other.

As shown in FIG. 6, the second radiator 630 may be formed in a coplanar waveguide with ground (CPW ground) structure, and it may be difficult to finely tune the resonance frequency of the second radiator 630 having the CPW ground structure. In the antenna device according to an embodiment, the two or more uneven parts 631 and 632 are formed in the second radiator 630, and the heights H1 and H2 and/or widths W1 and W2 of the uneven parts 631 and 632 are adjusted respectively, thereby it may be implemented so that the resonance frequency of the second radiator 630 having the CPW ground structure is more accurately matched with the desired second resonance frequency. That is, according to an embodiment, the length and width of the second radiator 630 may be determined to coarsely tune the resonance frequency of the second radiator 630 to the desired second resonance frequency, and the heights and/or widths of the respective uneven parts 631 and 632 may be determined to finely tune the resonance frequency of the second radiator 630 to the desired second resonance frequency. Thereby, it is possible to improve the radiation effect of the second radiator 630.

Meanwhile, for convenience of description, FIG. 6 illustrates only one antenna unit, a plurality of antenna units may be arranged on the upper surface of the dielectric layer in an array form. In this case, the separation distance between the antenna units may be greater than half of a wavelength corresponding to the resonance frequency (e.g., the first resonance frequency or the second resonance frequency) of the antenna unit in order to minimize radiation interference from each antenna unit.

FIG. 7 is a schematic plan view illustrating an antenna device according to another embodiment.

Referring to FIGS. 1 and 7, the antenna conductive layer 120 may include an antenna unit including a first radiator 210 and second radiators 230, a transmission line 220, a pad electrode 240, and a dummy pattern 250. Herein, the first radiator 210, the second radiator 230, the transmission line 220 and the pad electrode 240 are the same as those of the configuration described with reference to FIG. 2, therefore the same configuration will not be described in detail.

The dummy pattern 250 may be arranged around the first radiator 210, the transmission line 220, and the second radiators 230.

The dummy pattern 250 is formed in a mesh structure having substantially the same shape as at least one of the first radiator 210, the second radiator 230, and the transmission line 220, and may include the same metal as at least one of the first radiator 210, the second radiator 230 and the transmission line 220. According to an embodiment, the dummy pattern 250 may be formed in a segmented mesh structure.

The dummy pattern 250 may be disposed so as to be electrically and physically separated from the first radiator 210, the second radiators 230, the transmission line 220, and the pad electrode 240. For example, a separation region 251 may be formed along side lines or profiles of the first radiator 210, the second radiators 230 and the transmission line 220 to separate the dummy pattern 250 from the first radiator 210, the second radiators 230 and the transmission line 220.

As described above, by arranging the dummy pattern 250 having a mesh structure substantially the same as at least one of the first radiator 210, the second radiator 230 and the transmission line 220 around the first radiator 210, the second radiator 230, and the transmission line 220, it is possible to prevent the antenna unit from being viewed by the user of the display device on which the antenna device is mounted due to a difference in the electrode arrangement for each position.

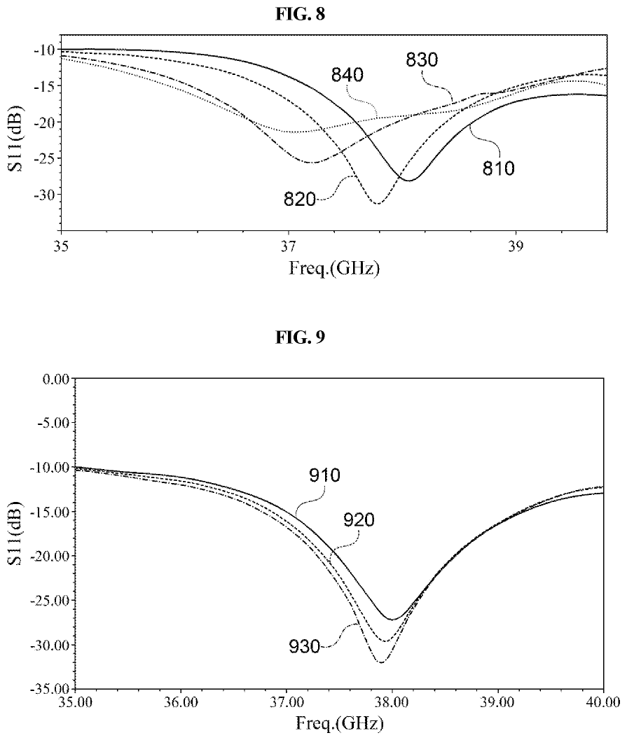

FIG. 8 is a diagram for describing a change in the resonance frequency of the second radiator depending on the height of the uneven part. More specifically, FIG. 8 is a graph illustrating S11 characteristics of the second radiator 230, when the width W of the uneven part 231 is fixed to 0.25 mm and the height H of the uneven part 231 is formed as 0 mm, 0.5 mm, 1 mm, and 1.5 mm in the embodiment of FIG. 2. In FIG. 8, a solid line 810 may denote an S11 characteristic of the second radiator when the uneven part has a height of 0 mm, a bold dotted line 820 may denote an S11 characteristic of the second radiator when the uneven part has a height of 0.5 mm, a dash-single dotted line 830 may denote an S11 characteristic of the second radiator when the uneven part has a height of 1 mm, and a fine dotted line 840 may denote an S11 characteristic of the second radiator when the uneven part has a height of 1.5 mm.

Referring to FIG. 8, it can be seen that, when the heights of the uneven part are 0 mm, 0.5 mm, 1 mm, and 1.5 mm, the second radiator resonates at frequencies of 38.044 GHz, 37.778 GHz, 37.200 GHz, and 37.022 GHz, respectively. That is, it can be seen that the resonance frequency of the second radiator varies depending on the height of the uneven part, and the resonance frequency of the second radiator may be finely tuned by adjusting the height of the uneven part.

FIG. 9 is a diagram for describing a change in the resonance frequency of the second radiator depending on the width of the uneven part. More specifically, FIG. 9 is a graph illustrating S11 characteristics of the second radiator 230, when the height H of the uneven part 231 is fixed to 0.5 mm and the width W of the uneven part 231 is formed as 125 μm, 375 μm, and 500 μm in the embodiment of FIG. 2. In FIG. 9, a solid line 910 may denote an S11 characteristic of the second radiator when the uneven part has a width of 125 μm, a dotted line 920 may denote an S11 characteristic of the second radiator when the uneven part has a width of 375 μm, and a dash-single dotted line 930 may denote an S11 characteristic of the second radiator when the uneven part has a width of 1 mm.

Referring to FIG. 9, it can be seen that, when the widths of the uneven part are 125 μm, 375 μm, and 500 μm, the second radiator resonates at frequencies of 38.000 GHz, 37.956 GHz, and 373.911 GHz, respectively. That is, it can be seen that the resonance frequency of the second radiator varies depending on the width of the uneven part, and the resonance frequency of the second radiator may be finely tuned by adjusting the width of the uneven part.

Therefore, as described above, by forming the uneven part in the second radiator and adjusting the height and/or width of the uneven part, it may be implemented so that the resonance frequency of the second radiator of the CPW ground structure is more accurately matched with the desired second resonance frequency. That is, the length and width of the second radiator may be determined to coarsely tune the resonance frequency of the second radiator to the desired second resonance frequency, and the height and/or width of the uneven part may be determined to finely tune resonance frequency of the second radiator to the desired second resonance frequency. Thereby, it is possible to improve the radiation effect of the second radiator.

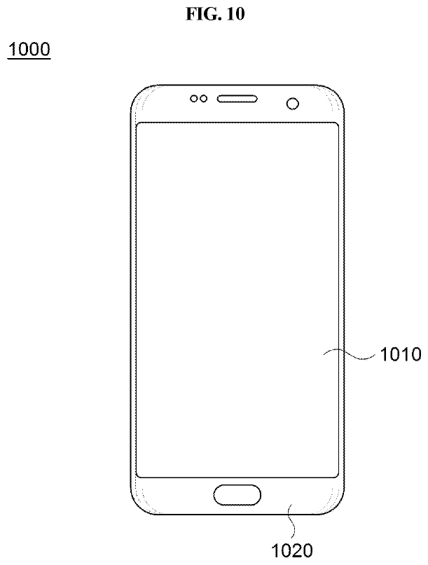

FIG. 10 is a schematic plan view illustrating an image display device according to exemplary embodiments. For example, FIG. 10 shows an external shape including a window of the display device.

Referring to FIG. 10, a display device 1000 may include a display region 1010 and a peripheral region 1020. The peripheral region 1020 may be disposed on both sides and/or both ends of the display region 1010, for example.

According to an embodiment, the above-described antenna device may be inserted into the display device 1000 in a form of a film or a patch. For example, the first radiator 210, the second radiators 230, 330, 430, 530, and 630 of the antenna device and the transmission line 220 may be disposed so as to at least partially correspond to the display region 1010 of the display device 1000, and the pad electrode 240 may be disposed to correspond to the peripheral region 1020 of the display device 1000.

The peripheral region 1020 may correspond to a light-shielding part or a bezel part of the image display device 1000, for example. A driving circuit such as an integrated circuit (IC) chip of the image display device 1000 and/or the antenna device may be disposed in the peripheral region 1020.

By arranging the pad electrode 240 of the antenna device so as to be adjacent to the driving circuit, signal loss may be suppressed by shortening a path for transmitting and receiving signals.

When the antenna device includes the dummy pattern 250, the dummy pattern 250 may be disposed so as to at least partially correspond to the display region 1010 of the display device 1000.

The antenna device includes the antenna unit and/or the dummy pattern, which are formed in a mesh structure, such that it is possible to significantly reduce or suppress the patterns from being viewed while improving the transmittance. Accordingly, image quality in the display region 1010 may also be improved while maintaining or improving desired communication reliability.

The present invention has been described with reference to the preferred embodiments above, and it will be understood by those skilled in the art that various modifications may be made within the scope without departing from essential characteristics of the present invention. Accordingly, it should be interpreted that the scope of the present invention is not limited to the above-described embodiments, and other various embodiments within the scope equivalent to those described in the claims are included within the present invention.

What is claimed is:

1. An antenna device comprising:
a dielectric layer;
a first radiator disposed on an upper surface of the dielectric layer;
a transmission line whose one end is connected with the first radiator on the upper surface of the dielectric layer;
a signal pad connected to the other end of the transmission line;
ground pads disposed around the signal pad; and
a second radiator extending from the ground pad parallel to the transmission line and including one or more uneven parts.

2. The antenna device according to claim 1, wherein the one or more uneven parts are formed on one side of the second radiator facing the first radiator.

3. The antenna device according to claim 1, wherein a height and a width of each of the one or more uneven parts are determined depending on a desired resonance frequency of the second radiator.

4. The antenna device according to claim 1, wherein the second radiator is electrically 0 and physically spaced apart from the first radiator and the transmission line.

5. The antenna device according to claim 1, wherein the second radiator and the ground pad are formed as a single member.

6. The antenna device according to claim 1, wherein the second radiator is formed in a mesh structure, and the ground pad is formed in a solid structure.

7. The antenna device according to claim 1, wherein the resonance frequency of the second radiator is higher than the resonance frequency of the first radiator.

8. The antenna device according to claim 1, wherein the second radiator includes a pair of second radiators disposed so as to face each other with the transmission line interposed therebetween on the upper surface of the dielectric layer.

9. The antenna device according to claim 1, wherein at least one of the first radiator, the transmission line and the second radiator is formed in a mesh structure.

10. The antenna device according to claim 1, further comprising a ground layer disposed on a lower surface of the dielectric layer.

11. A display device comprising the antenna device according to claim 1.
